(19) United States
(12) Patent Application Publication
(10) Pub. No.: US 2007/0095597 A1
(43) Pub. Date: May 3, 2007

(54) Variable steering rack system

(76) Inventors: Yong Seob Lim, Hwaseong-city (KR); Min Chul Shin, Gunpo-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,732

(22) Filed: Dec. 15, 2005

(30) Foreign Application Priority Data
Oct. 20, 2005 (KR) 10-2005-0099161

(51) Int. Cl. B62D 5/06

(52) U.S. Cl. 180/428

(57) ABSTRACT

A variable steering rack system includes: a movable steering rack bar; a case with a through-hole through which the steering rack bar penetrates; a stopper with a second through-hole through which the steering rack bar penetrates, disposed in the first through-hole and rotatable through a predetermined angle, and regulating a displacement of the steering rack bar as much as the thickness thereof; a stopper housing connected to the case such that the stopper is disposed therebetween and defining a groove; an intermediate gear with a bar on a surface thereof inserted into the groove of the stopper housing, and rotating the stopper; and an operating portion operating the intermediate gear, wherein the groove of the stopper housing is configured to limit a movement of the bar such that the stopper rotates only as much as the predetermined angle.

### CROSS-REFERENCE TO RELATED APPLICATION

This application claims priority to and the benefit of Korean Patent Application No. 10-2005-0099161 filed in the Korean Intellectual Property Office on Oct. 20, 2005, the entire contents of which are incorporated herein by reference.

### BACKGROUND OF THE INVENTION

(a) Field of the Invention

The present invention relates to a variable steering rack system. More particularly, the present invention relates to a variable steering rack system having less noise when the system is operating.

(b) Description of the Related Art

Generally, a variable steering rack system can regulate a maximum displacement of wheels of a vehicle when chains are mounted to tires of the vehicle.

Referring to FIG. 1 and FIG. 2, according to the prior art, a steering system including a variable steering rack system includes a gear box 10, a steering rack bar 19, a stop knob 17, a case 13, a stopper 15, a motor case 11, a motor 21, a motor gear 22, and an intermediate gear 23.

The motor case 11, the stopper 15, and the case 13 are orderly coupled to the gear box 10, and a groove is formed on an interior circumference of the motor case 11.

The stopper 15 is rotatable along the groove by the motor 21.

The stop knob 17 is secured to the steering rack bar 19 and when the variable steering rack system is not operating, the stop knob 17 is inserted into an interior circumference of the stopper 15.

When the variable steering rack system is operating, because the stopper 15 rotates corresponding to a movement of the steering rack bar 19, the stop knob 17 is not inserted into the stopper 15.

Therefore, the displacement of the steering rack bar 19 is restricted by as much as the thickness of the stopper 15.

The motor 21 transmits a torque to an intermediate gear 23 and the intermediate gear 23 rotates the stopper 15.

A stop protrusion 33 is formed in the groove of the interior circumference of the motor case 11 and a knob 31 is formed in the stopper 15.

Therefore, as the stopper 15 rotates along the groove in the interior circumference of the case 11, if the stop protrusion 33 contacts to the knob 31 of the stopper 15, the stopper 15 stops rotating.

Generally, according to the prior art, because the motor 21 utilized in the variable steering rack system rotates at a high speed, a colliding sound is very loud when the stop protrusion 33 contacts with the knob 31 of the stopper 15.

In addition, a moving range of the steering rack bar 19 can be controlled by as much as a displacement of the thickness of the stopper 15.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a variable steering rack system having advantages of less noise and enhanced durability.

An exemplary variable steering rack system that can variably regulate a maximum displacement of a steering rack bar, according to a first embodiment of the present invention includes: a steering rack bar defining a stop protrusion at a predetermined position and moving by a power transmitted from a steering gear box; a case defining a first through-hole through which the steering rack bar penetrates; a stopper defining a second through-hole through which the steering rack bar penetrates, being engaged to an inner circumference of the first through-hole to be rotatable through a predetermined angle, and regulating a displacement of the steering rack bar as much as its thickness; a stopper housing connected to the case such that the stopper is disposed therebetween and defining a groove; an intermediate gear with a bar protruding therefrom that is inserted to the groove of the stopper, and rotating the stopper; and an operating portion operating the intermediate gear, wherein the groove of the stopper housing is configured to limit a movement of the bar such that the stopper rotates only as much as the predetermined angle.

A rubber layer is formed on at least a portion of an exterior circumference of the bar and is rotatable around the bar. A synthetic resin is coated on at least a portion of the surface of the stopper. The bar has a circular cross-section.

According to a second embodiment of the present invention, a variable steering rack system includes: a steering rack bar defining a stop protrusion and moving by a power transmitted from a steering gear box; a case defining a first through-hole through which the steering rack bar penetrates; a stopper defining a second penetration hole through which the steering rack bar penetrates, being engaged to an inner surface of the first penetration hole to be rotatable through a predetermined angle, and regulating a displacement of the steering rack bar as much as the predetermined thickness corresponding to the rotation thereof; a stopper housing connected to the case such that the stopper is disposed therebetween and defining a groove; an intermediate gear rotating the stopper; and an operating portion operating the intermediate gear.

The predetermined angle is preferably between 45° and 60°.

### BRIEF DESCRIPTION OF THE DRAWINGS

FIG. 1 shows a steering system including a variable steering rack system according to the prior art.

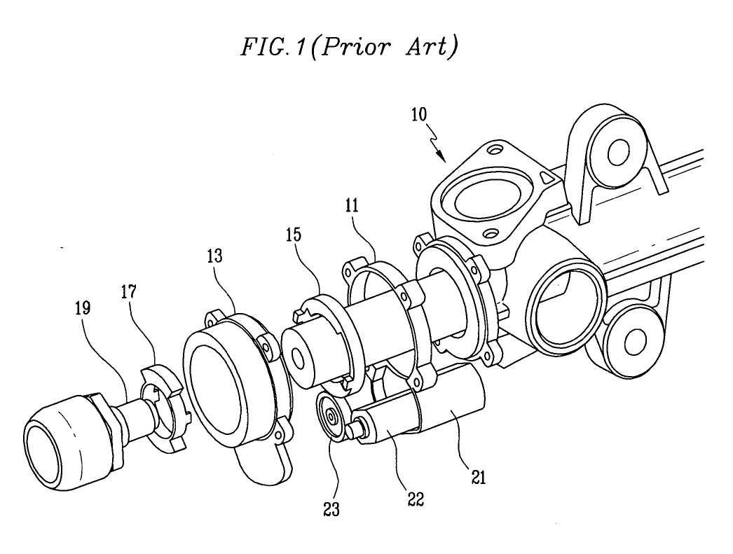

FIG. 2 shows a variable steering rack system according to the prior art.

FIG. 3 shows a variable steering rack system according to a first exemplary embodiment of the present invention with the stopper housing removed for clarity.

FIG. 4 shows a variable steering rack system according to the first exemplary embodiment of the present invention.

FIG. 5 shows a steering rack bar and a stopper of the variable steering rack system according to embodiments of the present invention.

FIG. 6 shows a predetermined angle of a variable steering rack system according to a second exemplary embodiment of the present invention.

### DETAILED DESCRIPTION OF THE PREFERRED EMBODIMENTS

An exemplary embodiment of the present invention will hereinafter be described in detail with reference to the accompanying drawings.

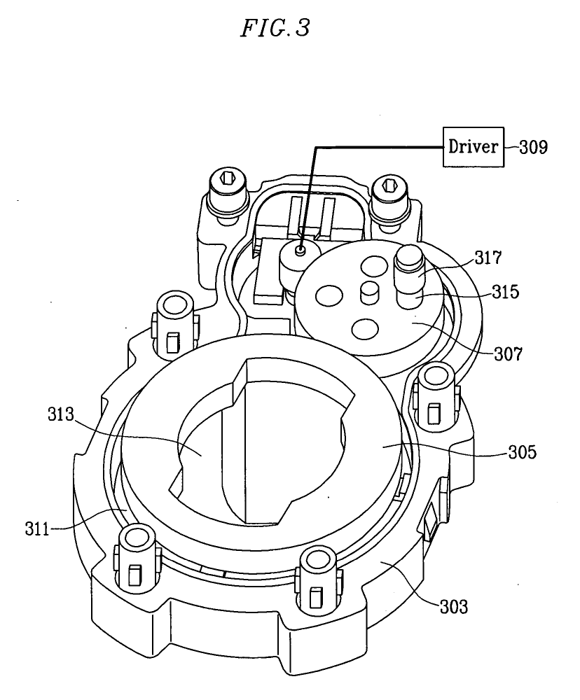

Referring to FIG. 3 to FIG. 5, embodiments of the variable steering rack system include a steering rack bar 301, case 303, a stopper 305, a stopper housing 501, an intermediate gear 307, and an operating portion 309.

The steering rack bar 301 defines a stop protrusion 403 at a predetermined position and moves by a power transmitted from a steering gear box 401.

The case 303 defines a first through-hole 311 through which the steering rack bar 301 penetrates. The case 303 can be integrally formed with the gear box 401. The stopper 305 defines a second through-hole 313 through which the steering rack bar 301 penetrates.

In addition, the stopper 305 is engaged to an inner circumference of the first through-hole 311 to be rotatable through a predetermined angle, and regulates a displacement of the steering rack bar 301 as much as the thickness of the stopper.

The stopper housing 501 is connected to the case 303 such that the stopper 305 is disposed therebetween. The stopper housing 501 defines a groove 503.

The intermediate gear 307 is configured such that a bar 315, perpendicularly formed thereto, is inserted to the groove 503 of the stopper housing 501 and rotates the stopper 305. The operating portion 309 operates the intermediate gear 307.

The groove 503 of the stopper housing 501 limits a movement of the bar 315 such that the stopper 305 rotates only as much as the predetermined angle.

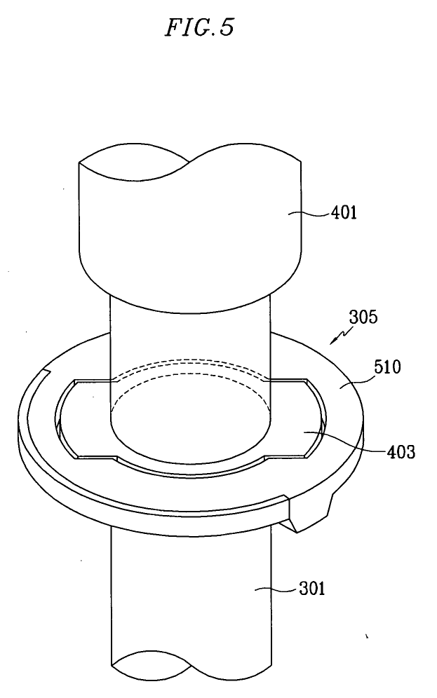

As shown in FIG. 5, the steering rack bar 301 is movably connected to the gear box 401 and moves in an up and down direction in FIG. 5 by a power transmitted from the gear box 401.

The stopper 305 is rotatably connected to the interior circumference of the first penetration hole 311, rotatable through the predetermined angle, and the stop protrusion 403 of the steering rack bar 301 may be inserted to the second penetration hole 313.

That is, when the stop protrusion 403 is inserted to the second through-hole 313, the range of motion of the steering rack bar 301 widens. If the stop protrusion 403 is not inserted to the stopper 305 so that the stopper 305 rotates as much as the predetermined angle, the range of motion of the steering rack bar 301 is limited by the thickness of the stopper 305.

According to an exemplary embodiment of the present invention, the operating portion 309 may be a motor, and the operating portion 309 operates the intermediate gear 307.

If the operating portion 309 rotates the intermediate gear 307, the intermediate gear 307 rotates the stopper 305 by as much as the predetermined angle.

That is, the stop protrusion 403 of the steering rack bar 301 may be selectively inserted to the second through-hole 313 corresponding to the rotation of the stopper 305.

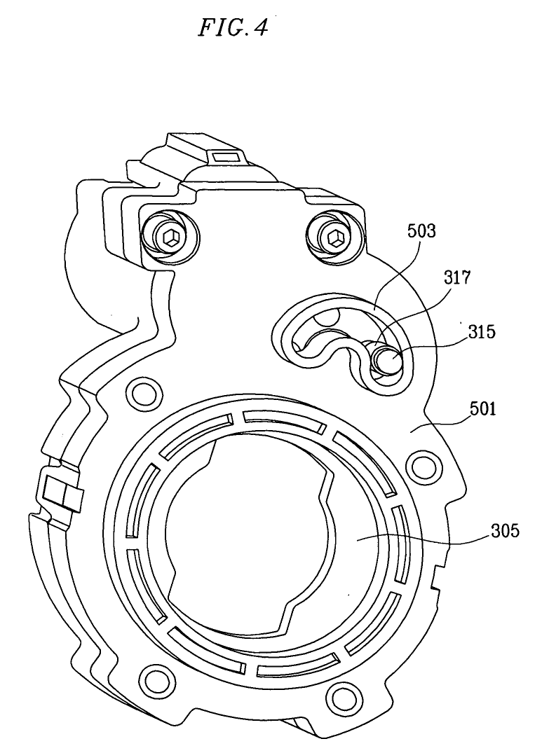

Referring to FIG. 3 and FIG. 4, the bar 315 is formed on the intermediate gear 307 and is coupled to the groove 503 of the stopper housing 501. That is, the movement of the bar 315 is limited by the groove 503. A detailed description of the groove 503 is provided later.

A rubber layer 317 is formed on at least a portion of an exterior circumference of the bar 315 such that the rubber layer 317 can rotate along the exterior circumference. More particularly, the rubber layer 317 is formed at a surface of the bar 315 which the groove 503 contacts. When the intermediate gear 307 rotates, the rubber layer 317 rotates along the groove 503. Therefore, when the movement of the bar 315 is limited by the groove 503, noise is prevented by the rubber layer 317.

A synthetic resin 510 coats a surface of the stopper 305 where the stopper 305 contacts the stop protrusion 403 or the case 303. Therefore, when the stop protrusion 403 of the steering rack bar 301 contacts the stopper 305 or the stopper 305 rotates through the predetermined angle, noise is reduced.

The bar 315 has a circular cross-section so that it can move more easily within the groove 503.

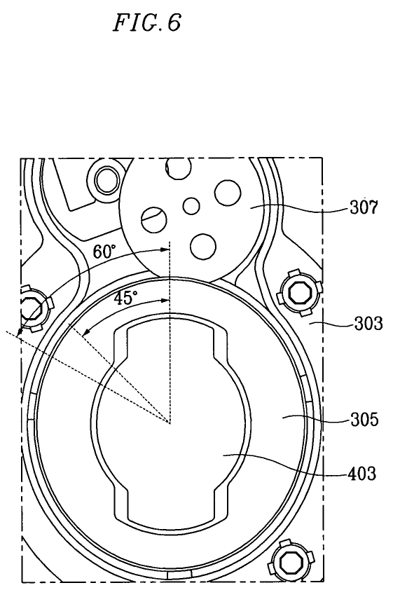

Referring to FIG. 6, a variable steering rack system of a second exemplary embodiment of the present invention does not include the bar 315, the rubber layer 317, or the coated synthetic resin 5 10.

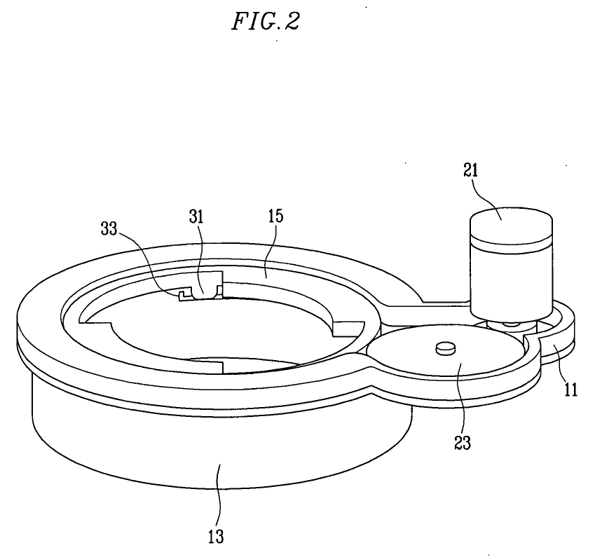

In the second exemplary embodiment of the present invention, the stopper 305 stops in the same method as shown in FIG. 2; that is, stopper 305 comprises a knob 31 (not shown in FIG. 6) that contacts stop protrusion 33 (not shown in FIG. 6) to stop the stopper 305 from rotating. However, the stopper 305 of the second exemplary embodiment of the present invention moves through an angle of between 45° and 60°. Because the angle that the stopper 305 rotates is small, the impact force when the knob 31 of the stopper 305 collides to the stop protrusion 33 is reduced. Therefore, noise of the impact force is reduced.

According to a result of an experiment, if the stopper 305 rotates 45°, about 27% of the noise is reduced and if the stopper 305 rotates 60°, about 10% of the noise is reduced.

According to the first exemplary embodiment of the present invention, when the variable steering rack system operates, the noise is reduced by the rubber layer and the synthetic resin coating. According to the second exemplary embodiment of the present invention, the noise is reduced by a decrease in the impact force of the stopper due to the small rotating angle of the stopper. Therefore, durability of the variable steering rack system may be enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A variable steering rack system comprising:
a steering rack bar comprising a stop protrusion and movable by a power transmitted from a steering gear box;
a case comprising a first through-hole through which the steering rack bar penetrates;
a stopper disposed in the first through-hole to be rotatable through a predetermined angle, and comprising a second through-hole through which the steering rack bar penetrates, said stopper regulating a displacement of the steering rack bar as much as a thickness thereof;
a stopper housing comprising a groove and connected to the case such that the stopper is disposed between said case and said stopper housing;
an intermediate gear that rotates the stopper, said intermediate gear comprising a bar projecting from a surface thereof, wherein said bar is inserted into the groove of the stopper housing; and
an operating portion that operates the intermediate gear,
wherein the groove of the stopper housing is configured to limit a movement of the bar such that the stopper rotates only as much as the predetermined angle.

2. The system of claim 1, wherein the bar of the intermediate gear comprises a rubber layer on at least a portion of an exterior circumference of the bar.

3. The system of claim 2, wherein the rubber layer is rotatable along the at least a portion of an exterior circumference of the bar.

4. The system of claim 1, wherein a synthetic resin is coated on at least a portion of a surface of the stopper.

5. The system of claim 1, wherein the bar comprises a substantially circular cross-section.

6. A variable steering rack system comprising:
a steering rack bar comprising a stop protrusion and movable by a power transmitted from a steering gear box;
a case comprising a first through-hole through which the steering rack bar penetrates;
a stopper comprising a second through-hole through which the steering rack bar penetrates, said stopper being disposed in the first through-hole to be rotatable through a predetermined angle, and regulating a displacement of the steering rack bar as much as a thickness thereof;
a stopper housing comprising a groove and connected to the case such that the stopper is disposed between said case and said stopper housing;
an intermediate gear that rotates the stopper; and
an operating portion operating the intermediate gear.

7. The system of claim 6, wherein the predetermined angle is between about 45° and about 60°.

8. The system of claim 7, wherein the predetermined angle is about 45°.

9. The system of claim 7, wherein the predetermined angle is about 60°.
